(19) United States
(12) Patent Application Publication
(10) Pub. No.: US 2018/0357861 A1
(43) Pub. Date: Dec. 13, 2018

(54) Gaming Machine and Method

(71) Applicant: Ainsworth Game Technology Limited, Newington (AU)

(72) Inventor: William George Cormack, Dural (AU)

(21) Appl. No.: 15/993,126

(22) Filed: May 30, 2018

Related U.S. Application Data
(60) Provisional application No. 62/518,782, filed on Jun. 13, 2017.

(51) Int. Cl. G07F 17/32

(52) U.S. Cl. CPC G07F 17/3267; G07F 17/3288; G07F 17/3244; G07F 17/3213

(57) ABSTRACT

A gaming machine includes a display, a value input, and an electronic controller. The controller is configured to determine if a wager has been received, and to display a first game on the at least one display including one or more configurations of game symbols in an array of game symbol positions, one or more of the configurations of game symbols being associated with a game outcome, the game outcome being associated with an prize payable to a player. The controller is also configured to determine if a trigger event has occurred during a play of the first game, and if the trigger event has occurred, to randomly determine a number of free plays for a second game.

### BACKGROUND

This patent is directed to a gaming machine and method incorporating a second game with a randomly determined number of plays, and optionally an intermediate event prior to the second game, which second game may be a bonus game.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines provide a base or main game where various configurations of game symbols are displayed on a screen, with the game symbols typically organized into three rows and five columns (a 5×3 array). Other arrays, such as a 3×3 or 4×3, may be used in the alternative. The gaming machine may randomly select the game symbols that appear in or on the array, each column of the array being a “reel”, and provide an award based on the randomly selected configuration. Alternatively, the gaming machine may select an outcome from a pool of outcomes, display a configuration of symbols in accordance with that outcome, and provide an award in accordance with the outcome.

Whether the outcome is determined by a random number generation or a pool of outcomes (or some other mechanism), there exists a set of rules that are consistently applied to the operation of the gaming machine. While the consistent operation of the machine is desirable from a regulatory perspective, the consistent operation of the machine according to the single set of rules may be viewed as staid, boring and redundant by the player. It is desirable to achieve variation in the operation of the machine, so that the player will view the machine as exciting and unique.

To this end, a gaming machine may operate to provide bonus or feature games in addition to a base or main game. These bonus or feature games can use the same set of reels as the main game, but with different rules, different paytables, and/or different probabilities relative to the appearance of certain outcomes. For that matter, the bonus or feature games may use different reel strips as well. By providing a bonus or feature game in addition to the base or main game, the operation of the gaming machine may be varied so that the player is provided opportunities to receive an award that differ from the opportunities provided when the gaming machine is operating according to the base or main game.

A gaming machine that provides both a main game and a bonus game may provide additional options for variation relative to the gaming machine that provides only a main game. Still, the range of the variation of the gaming machine is limited where the bonus game relies on the same set of reels used in the main game.

It is an object of the present invention to overcome or substantially ameliorate one or more of the disadvantages of prior art, or at least to provide a useful alternative.

### SUMMARY

The present invention provides a gaming machine that has improved operation and performance relative to existing prior art gaming machines. As such, the gaming machine and associated method according to the invention provides an improved gaming machine in that the award of enhanced prizes is performed differently and in a more entertaining manner compared to presently existing gaming machines

One embodiment provides a gaming machine comprising:

at least one display;

at least one electronic controller coupled to the at least one display, the at least one controller configured:
to display a first game on the at least one display including one or more configurations of game symbols in an array of game symbol positions, one or more of the configurations of game symbols being associated with a game outcome; the game outcome being associated with an prize payable to a player;
to determine if a trigger event has occurred during a play of the first game, and if the trigger event has occurred, to randomly determine a number of free plays for a second game.

An additional embodiment provides a gaming machine comprising:

at least one display;

a value input comprising at east one of a coin acceptor, a bill acceptor and a ticket reader; and

at least one electronic controller coupled to the at least one display and the value input, the at least one controller configured:
to determine if a wager has been received via the value input;
to display a first game on the at least one display including one or more configurations of game symbols in an array of game symbol positions if a wager has been received, one or more of the configurations of game symbols being associated with a game outcome; the game outcome being associated with an prize payable to a player;
to determine if a trigger event has occurred during a play of the first game, and if the trigger event has occurred, to randomly determine a number of free plays for a second game.

A further embodiment provides a method comprising:

displaying a first game on the at least one display including one or more configurations of game symbols in an array of game symbol positions, one or more of the configurations of game symbols being associated with a game outcome, the game outcome being associated with an prize payable to a player;

determining if a trigger event has occurred during a play of the first game, and if the trigger event has occurred, to randomly determine a number of free plays for a second game.

A still further embodiment provides a method comprising:

determining if a wager has been received via a value input comprising at least one of a coin acceptor, a bill acceptor and a ticket reader,

displaying a first game on the at least one display including one or more configurations of game symbols in an array of game symbol positions if a wager has been received, one or more of the configurations of game symbols being associated with a game outcome, the game outcome being associated with an prize payable to a player;

determining if a trigger event has occurred during a play of the first game, and if the trigger event has occurred, to randomly determine a number of free plays for a second game.

A further embodiment provides a computer system comprising a central processing unit configured for communication with a gaming machine, wherein said computer system is configured to perform the method of any one of the above described embodiments.

A further embodiment provides a computer program configured to perform the method of any one of the above described embodiments.

A further embodiment provides a non-transitory carrier medium carrying computer executable code that, when executed on a central processing unit configured for communication with a gaming machine, causes the central processing unit to perform the method of any one of the above described embodiments.

Unless the context clearly requires otherwise, throughout the description and the claims; the words “comprise”, “comprising”, and the like are to be construed in an inclusive sense as opposed to an exclusive or exhaustive sense; that is to say, in the sense of “including; but not limited to”.

Furthermore, as used herein and unless otherwise specified; the use of the ordinal adjectives “first”, “second”, “third”, etc.; to describe a common object, merely indicate that different instances of like objects are being referred to; and are not intended to imply that the objects so described must be in a given sequence, either temporally, spatially, in ranking, or in any other manner.

### BRIEF DESCRIPTION OF THE DRAWINGS

The disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a perspective view of a gaming machine according to an embodiment of the present disclosure;

FIG. 2 is a block diagram of the components of the embodiment of the gaming machine of FIG. 1;

FIG. 3 is a simulated screenshot of a game played on the gaming machine of FIG. 1;

FIG. 4-6 are a flowchart of the operation of a gaming machine according to an embodiment of the present disclosure;

FIG. 7 is a simulated screenshot of a game played on the gaming machine of FIG. 1;

FIG. 8 is a simulated screenshot of a trigger event during a game played on the gaming machine of FIG. 1;

FIGS. 9-16 are simulated screenshots of an intermediate event played on the gaming machine of FIG. 1;

FIG. 17 is a simulated screenshot of another game played on the gaming machine of FIG. 1;

FIGS. 18 and 19 are simulated screenshots of another intermediate event played on the gaming machine of FIG. 1;

FIG. 20 is a perspective view of an electronic gaming machine according to yet another embodiment;

FIG. 21 is a block diagram of the electronic components of the electronic gaming machine of FIG. 20.

### DETAILED DESCRIPTION OF VARIOUS EMBODIMENTS

The present invention will now be described with reference to the following examples that should be considered in all respects as illustrative and non-restrictive.

In general terms, a gaming machine according to the embodiments described herein includes at least one display, a value input, and an electronic game controller coupled to the at least one display and the value input.

The game controller is configured to determine if a wager has been received via the value input. If a wager has been received, the controller is configured to display a first game on the at least one display including one or more configurations of game symbols in an array of game symbol positions. One or more of the configurations of game symbols are associated with a game outcome, which game outcome is associated with an prize payable to a player. The controller is also configured to determine if a trigger event has occurred during a play of the first game. If the controller determines that trigger event has occurred, then the controller randomly determines a number of free plays for a second game.

As illustrated, the at least one electronic controller may be configured to determine if the trigger event has occurred by determining if a threshold number of scatter symbols have appeared during a play of the first game. According to such an embodiment, where the scatter symbols appear in a first plurality of game positions during play of the first game, the electronic controller may be configured to hold the scatter symbols in the first plurality of game symbol positions during one or more plays of an intermediate event. The controller may also be configured to determine if additional scatter symbols appear in a second plurality of game symbol positions other than the first plurality of game symbol positions during the one or more plays of the intermediate event. The controller may be configured to randomly determine a number of additional free plays of the second game for each of the one or more additional scatter symbols that appear.

According to certain embodiments, including the illustrated embodiment, if the trigger event has not occurred, the controller may be configured to randomly determine if the second game is to be played, and if the second game is randomly determined to be played, determine a number of free plays for the second game. According to such an embodiments, the controller may also be configured to display an oversized game symbol that overlaps a first plurality of game symbol positions during one or more plays of an intermediate event, and to determine if additional scatter symbols appear in a second plurality of game symbol positions other than the first plurality of game symbol positions during the one or more plays of the intermediate event.

In either event, the controller may be configured to transition from the intermediate event to the second game. According to some embodiments, the second game may include one or more configurations of game symbols in an array of game symbol positions, one or more of the configurations of game symbols being associated with a game outcome, the game outcome being associated with an prize payable to a player, similar to the first game. According to other embodiments, the second game may be different from the first game.

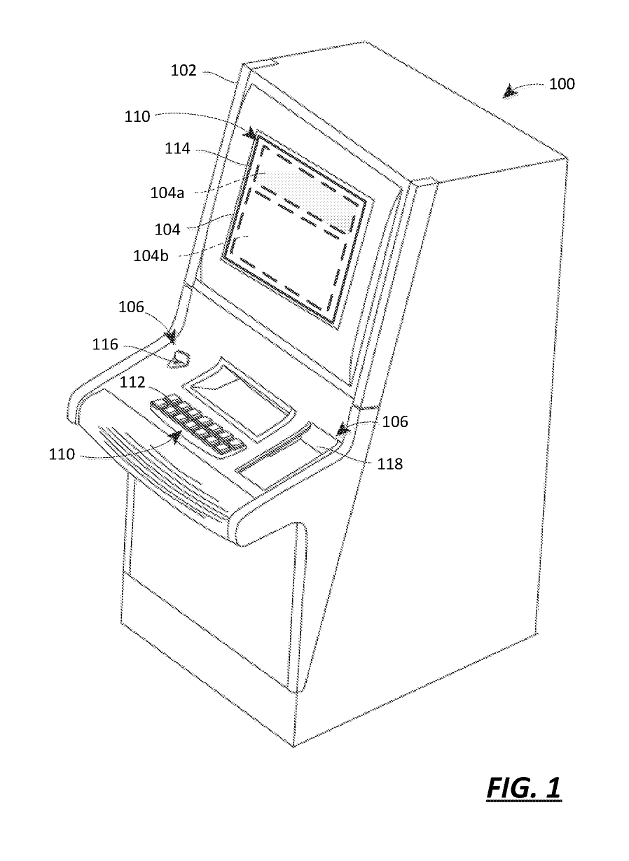

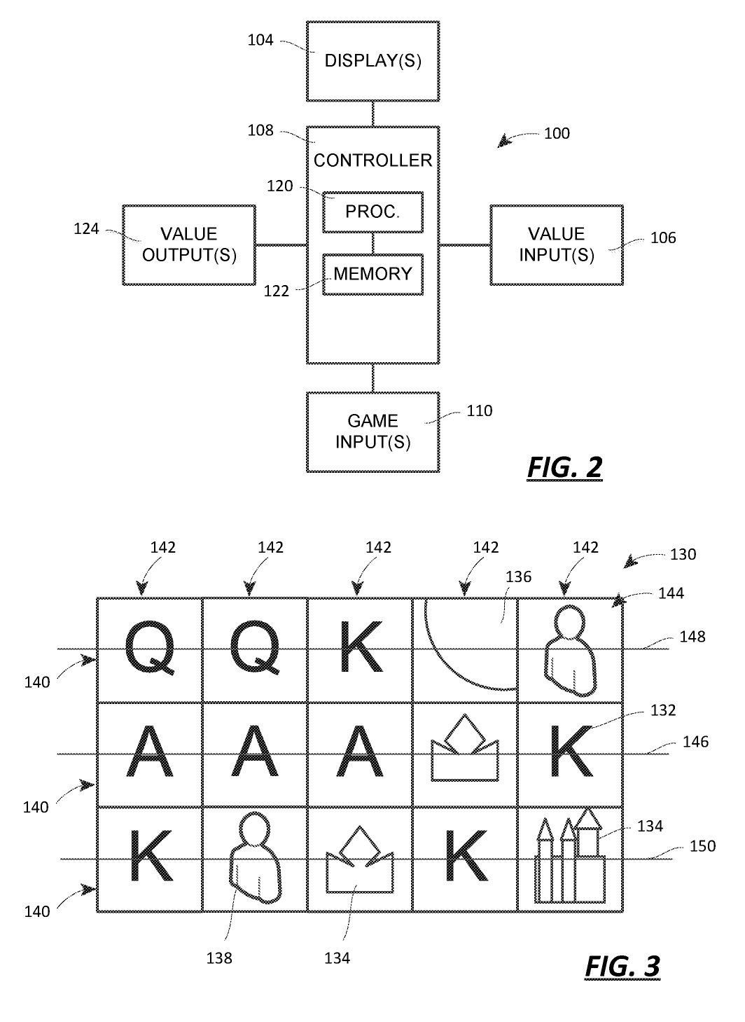

With reference now to FIG. 1, the gaming machine 100 may include a housing (or cabinet) 102 in which the at least one display 104 is mounted. With reference to FIGS. 1 and 2, the value input 106 and electronic controller 108 (see FIG. 2) may be mounted on or disposed within the housing 102. For example, the value input 106 may be mounted on the housing 102 such that at least part of the value input 106 is accessible by the player, while the electronic controller 108 is disposed (and secured) within the housing 102. A game input device 110, in the form of a set of buttons 112 or a touchscreen 114 as illustrated in FIG. 1, may be mounted on the housing 102 and accessible by the player to provide inputs to the electronic controller 108.

The at least one display 104 may be an electronic display, for example an electronic video display, such as a LED display or a plasma display as is illustrated in FIG. 1. The display 104 may include multiple sections, e.g., 104a, 104b, for displaying different information, games, etc. to the player, as illustrated in FIG. 1. According to other embodiments, separate displays may be used. In fact, according to certain embodiments, the at least one display may include at least a first mechanical, electromechanical or electronic display (e.g.; for the first game) and a second, separate mechanical, electromechanical or electronic display (e.g., for the second game).

According to certain embodiments, the value input 106 may be at least one of a coin acceptor, a bill acceptor and a ticket reader. According to certain embodiments, the value input 106 may include a coin acceptor, a bill acceptor and a ticket reader. For that matter, as illustrated, the value input 106 may include a coin acceptor 116 and a bill acceptor 118 that may function as a ticket reader as well, such that the value input 106 may be considered to include a bill acceptor and a ticket reader.

In a general sense, the value input 106 may be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the gaming machine 100. Other forms of value include gaming tokens, paper, tickets, vouchers, and any other object representative of value.

As illustrated in FIG. 2, the electronic game controller 108 may include a microprocessor 120 (which, in fact may include multiple physical and/or virtual processors). According to other embodiments, the controller 108 may include one or more electrical circuits designed to carry out the actions described herein. In fact, the controller may include a microprocessor 120 and other circuits or circuitry. In addition, the controller may include one or more memories 122. The instructions by which the microprocessor 120 is programmed may be stored on the memory 122 associated with the microprocessor 120, which memory/memories 122 may include one or more tangible non-transitory computer readable memories, having computer executable instructions stored thereon, which when executed by the microprocessor 120, may cause the microprocessors 120 to carry out one or more actions as described below.

The controller 108 may be directly or indirectly coupled to the display(s) 104, value input(s) 106, and game input(s) 110 mentioned above. The controller 108 may also be directly or indirectly coupled to one or more value output(s) 124, as indicated in FIG. 2. For example, the value output 124 may be coin or bill dispenser or a ticket writer; according to certain embodiments, the ticket reader and the ticket writer may be defined by a single, integrated physical device.

As mentioned above, the first game (and possibly the second game) includes one or more configurations of game symbols, one or more of the configurations or combinations of game symbols being associated with a game outcome, the game outcome being associated with a value award payable to a player. According to certain embodiments, the first game may be a primary game, although the first game may alternatively be a bonus game or event. For that matter, the second game may be a bonus game or event.

According to certain embodiments, the game symbols may be used to play a slots-type game. According to other embodiments, the game symbols may be used to play a poker-type game. According to still other embodiments, the game symbols may be used to play a bingo or keno-type game.

According to certain embodiments, the game symbols are organized into three rows and five columns (a 5×3 array). Other arrays, such as a 3×3 or 4×3, may be used in the alternative. The electronic controller 108 may randomly select the game symbols that appear in or on the array (e.g., using a random number generator, which may be incorporated into the machine 100, for example in the electronic controller 108), each column of the array corresponding to a reel in a mechanical or electromechanical display, and provide an award based on the randomly selected configuration. Alternatively, the machine 100 (or a server associated with the machine 100) may select an outcome from a pool of outcomes, and the machine 100 may display a configuration of symbols in accordance with that outcome, and provide an award in accordance with the outcome.

According to an embodiment illustrated in FIG. 3, play of the first game 130 includes generation of a plurality of randomly selected game symbols 132, 134, 136, 138, which symbols 132, 134, 136, 138 are arranged in a plurality of rows 140 and columns 142, which columns 142 may each correspond to a reel in a mechanical or electromechanical display. The rows 140 and columns 142 may define an array 144.

Each of the game symbols 132, 134, 136, 138 is disposed in a game position. As illustrated, the game positions are demarked with a solid border or boundary line. According to other embodiments, the boundary lines between game symbols in the same column 142 may be not be visible or there may be no boundaries. It is also possible for the boundary lines between game symbols in game positions along a row 140 to be omitted or not visible.

The game symbols 132, 134, 136, 138 are non-limiting examples of game symbols that may be present in a play of the game of the illustrated embodiment. For example, the game symbols may represent card ranks (or ordinal values) 132 or objects 134. The game symbols may also include scatter symbols 136 used as part of the trigger event according to the embodiments described below. Further game symbols may be WILD symbols 138, which may be used in place of the game symbols 132, 134 when determining if a winning combination of game symbols is present.

According to the illustrated embodiment, the game symbols 134, 136, 138 may be defined according to a theme, such as a princess or goddess theme. Accordingly, the object game symbols 134 may include crowns and castles, for example. In addition, the scatter symbol 136 may include images of a moon, whether shown in whole or in part. Further, the WILD symbols 138 may include a figure that is intended to represent the princess or goddess.

A winning combinations of game symbols may be determined according to the game symbols arranged along a payline 146, 148, 150, winning combinations of game symbols associated with a value award provided to the player. While three exemplary paylines 146, 148, 150 are illustrated in FIG. 3, it will be recognized that additional paylines may be included in other embodiments. Further, it is conventional that only game symbols 132, 134, 138 arranged along an active payline (one on which the player has made a wager) will be considered. For example, an arrangement of three or more instances of the same game symbol on an active payline (e.g., the three instances of “A” on the payline 146) may result in a value award, with different game symbols resulting in lower or higher value awards.

As mentioned above, the occurrence of a trigger event causes the transition from the first game, as illustrated in FIG. 3, to a second game. According to the illustrated embodiments, the transition from the first game to the second game may occur with an intermediate event, which event may be associated with one or more awards payable to the player. For example, the intermediate event potentially may include a jackpot award. According to other embodiments, the intermediate event may be playable as a separate and distinct game, which could be triggered from a first game, such as is illustrated in FIG. 3

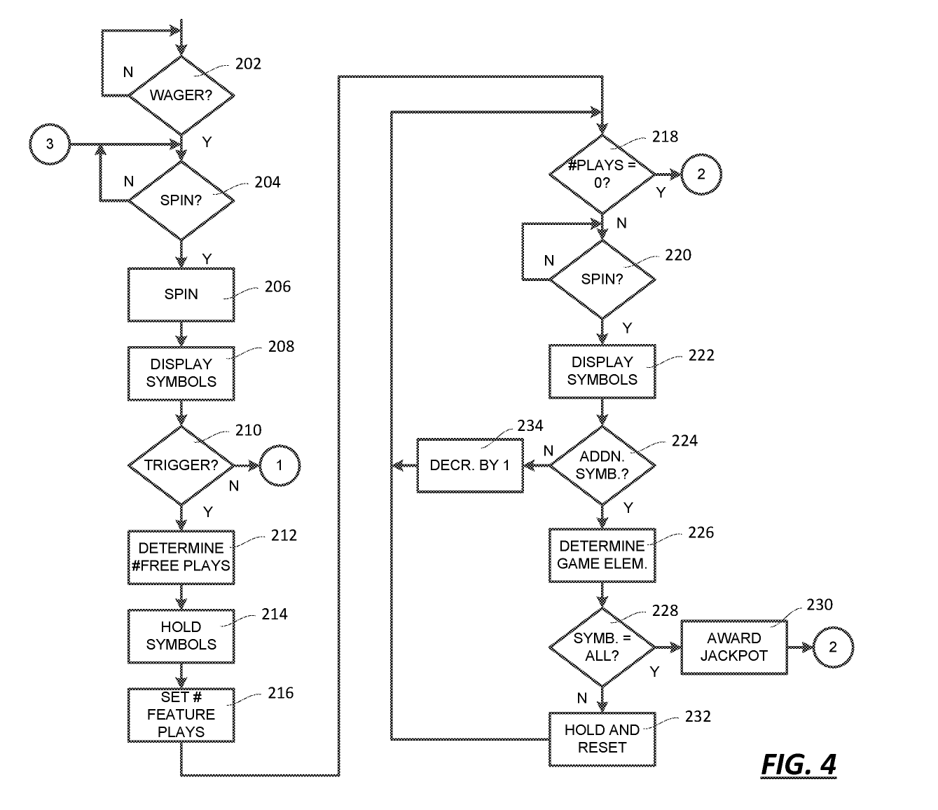

FIGS. 4-6 illustrate an embodiment of a method 200 for operating the gaming machine 100, which method 200 may be carried out using the display(s) 104, value input(s) 106 and controller(s) 108 discussed above. The operation of the machine 100 may also include the use of the game input(s) 110 and value output(s) 124. While an embodiment of a method for operating the machine 100 is illustrated, it will be understood that the method may include a fewer or greater number of actions than are illustrated in FIGS. 4-6. Further, as explained below, the sequence of actions may vary among embodiments of the method, such that the sequence of particular actions as illustrated is not critical unless specified.

The illustrated embodiment of the method 200 begins at block 202, where the controller 108 determines if a wager has been received via the value input(s) 106. If the controller 108 does not detect a wager, the controller 108 waits until a wager has been received. If the controller 108 determines that a wager has been received, the controller 108 displays a first game on the at least one display 104, including one or more configurations of game symbols 132, 134, 136, 138 in an array of game symbol positions 130. One or more of the configurations of game symbols 132, 134, 136, 138 are associated with a game outcome, which game outcome is associated with an prize payable to a player.

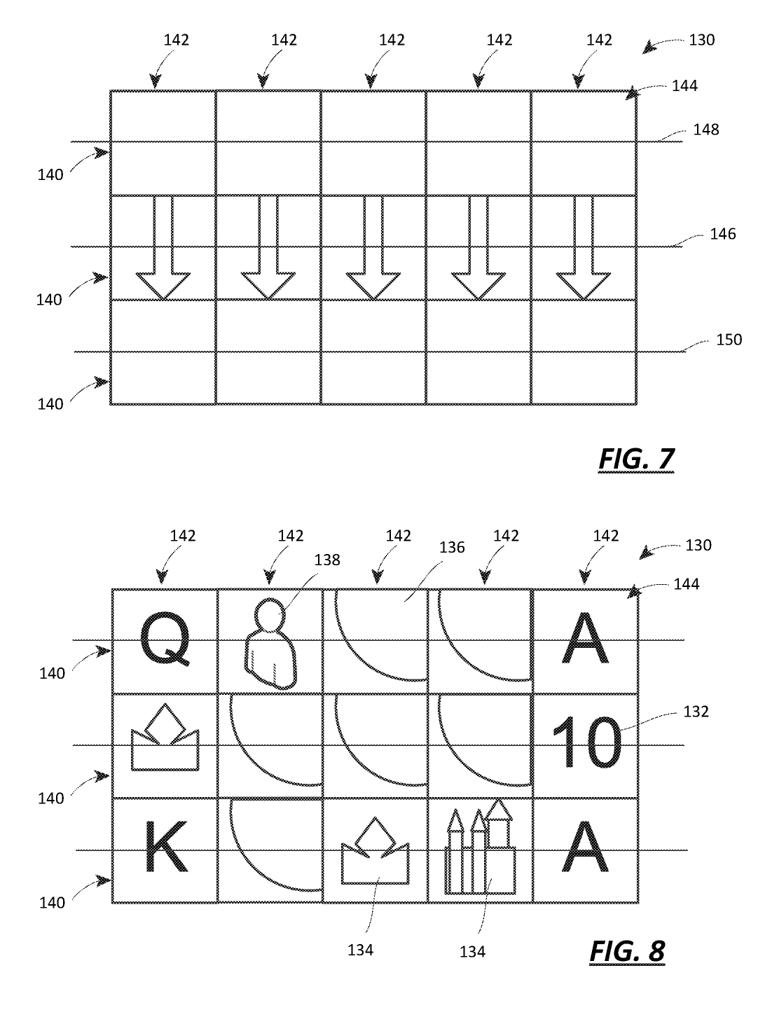

In particular, the method 200 may continue from block 202 to block 204, where the controller 108 determines if the player has used the game input(s) 110, for example, to start the first game. When the controller 108 determines that the player has used the game input(s) 110 to start the first game, the controller 108 may display an image, such as illustrated in FIG. 7, wherein an animation of a spinning reel is provided for each of the columns 142 (block 206). According to other embodiments, the controller may display an image where an animation of a spinning reel is provided for each of the game symbol positions of the array 144. The animation may be of a downwardly pointing arrow and/or a blurred image of the game symbols as if they were in movement in a downward direction in the column 142. After a time period has elapsed or when the player actuates a further control, for example, the controller 108 causes the display 104 to display a plurality of game symbols 132, 134, 136, 138 (block 208), such as is illustrated in FIG. 8. As illustrated in FIG. 8, there are card symbols 132, object symbols 134, and WILD symbols 138. In addition, there are a number of scatter symbols 136.

The method 200 continues to block 210, where the controller 108 determines if a trigger event has occurred during a play of the first game. If the controller 108 determines that trigger event has occurred, then the controller 108 may award a trigger award or prize (e.g., an amount of credits, such as 300 credits). In addition or alternatively, the controller 108 randomly determines a number of free plays for a second game at block 212. The free plays of the second game may also be referred to as “free games”, but the intent is to represent the same action: one or more repeated opportunities to play the second game to receive awards (prizes).

As illustrated, the controller 108 may be configured to determine if the trigger event has occurred by determining if a threshold number of scatter symbols 136 have appeared during a play of the first game 130. For example, the controller 108 may determine whether six or more of the scatter symbols 136 have appeared in the array 144. According to certain embodiments, the number of scatter symbols 136 that may appear may have an upper limit as well; for example where the scatter symbols 136 only appear in three of the five columns or reels 142, no more than nine scatter symbols 136 could appear in the first game 130. If six or more of the scatter symbols 136 appear, then the controller 108 randomly determines a number of free plays for the second game at block 212. If five or fewer scatter symbols 136 are displayed, then the trigger event has not occurred.

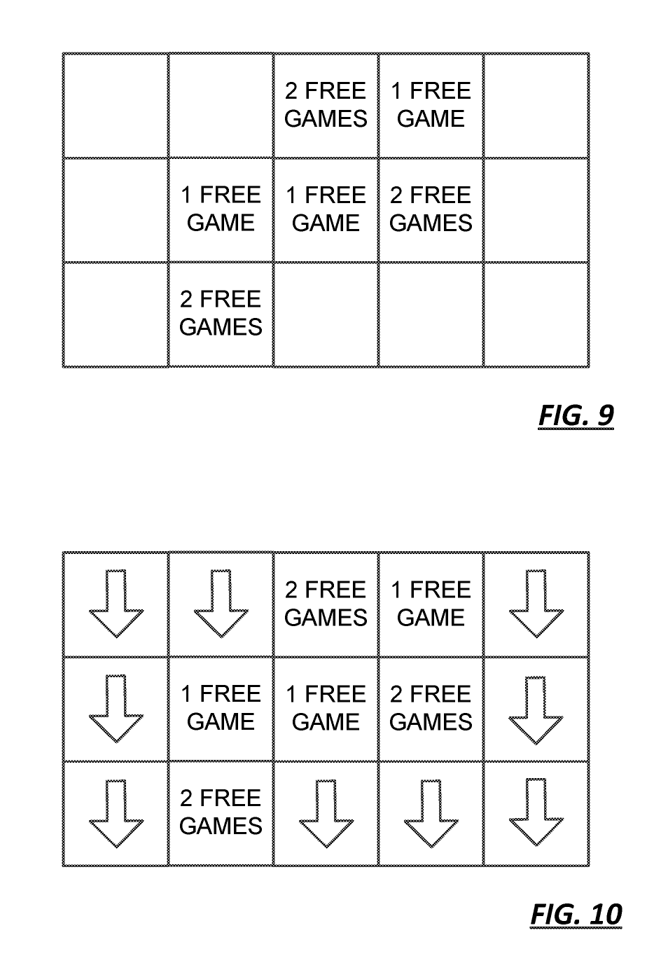

The determination of how many free plays of the second game are provided to the player may vary between embodiments of the method for operating the machine 100. For example, as illustrated, the controller 108 may make a separate assessment for each of the scatter symbols 136 that are displayed in the array 144, and may randomly determine the number of free plays associated with each of the scatter symbols. See, e.g., FIG. 9. For example, the controller 108 may randomly generate a number that directly correlates to a number of free plays within a specific range (e.g., between 1 and 15), or the controller 108 may randomly generate a number that is within a series of ranges, each range associated with a specific number of free plays (e.g., 1 to 10 are associated with 1 free play, 11 to 20 are associated with 2 free plays, 21 to 30 are associated with 3 free plays, and so on). The total number of free plays provided to the player may be the sum of the free plays associated with each of the scatter symbols, for example (such as 9 free plays for the illustrated embodiment of FIG. 9). According to other embodiments, a randomly determined number may be assigned to the group of scatter symbols 136 that triggers the second game (which number then may be associated with each individual symbol 136, or may be distributed over the symbols 136 such as by equal division among the symbols, for example).

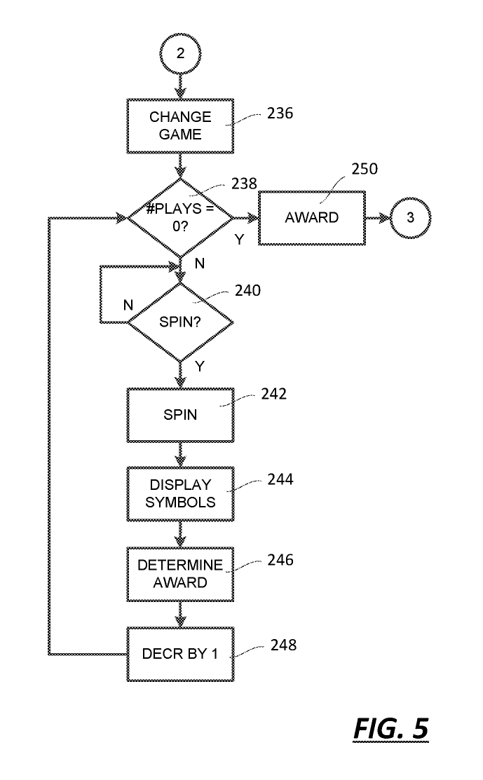

According to certain embodiments, the method of operation of the machine 100 may continue at this point directly to the second game, the operation of which is illustrated in FIG. 5. According to the illustrated embodiment, the method 200 instead continues to block 214, where an intermediate event begins (for example, in response to a player input received via the inputs 110).

At block 214, the controller 108 holds the scatter symbols 136 in a first plurality of game symbol positions during one or more plays of the intermediate event. That is, during plays of the intermediate event, the game symbol positions corresponding to those game symbol positions where a scatter symbol occurred in the first game are not re-evaluated, or re-spun, during the intermediate event. As the outcome of the intermediate event is determined by the number of game symbol positions are occupied by scatter symbols either during the play of the first game that triggered the second game (and the intermediate event) or plays of the intermediate event, these game positions are considered as counting toward the total number of occupied game symbol positions. It will be recognized that for an embodiment where the intermediate event is provided, it is not necessary that the symbols 136 are held at block 214 before the number of free plays are determined at block 212, but the actions may occur in the reverse order.

Where, as illustrated, the method 200 includes more than one play of the intermediate event, the controller 108 may set a limit at block 216 on the number of plays of the intermediate event that may occur if the player is not successful and does not win the intermediate event before the limit is reached. Where the embodiment of the method of operation includes only one play of the intermediate event, the block 216 may be omitted.

In particular, the controller 108 may set a limit on the number of plays of the intermediate event in the form of a fixed, or static, limit (i.e., 5 free plays of the intermediate event) at block 216. Such an intermediate event would operate similarly to the second game, illustrated in FIG. 5, in this regard. On the other hand, as is the case according to the illustrated embodiment, the controller 108 may set a changing, or dynamic, limit on the number of plays of the intermediate event. That is, the controller 108 may initialize the limit to three free plays of the intermediate event at block 216. If a further play of the intermediate event results in at least one additional scatter symbol 136 being displayed in the array 144, then the limit is reset to 3 free plays (assuming that the player does not successfully complete the intermediate event with the at least one additional scatter symbol 136). However, for each play of the intermediate event that does not result in at least one additional scatter symbol 136 being displayed, the limit is decreased by one. When the limit reaches zero (0), the intermediate event terminates.

The method 200 may continue to block 218, where the controller 108 determines if the limit is equal to zero (0), i.e., if the number of plays of the intermediate event has reached zero (0). If not, the method may continue to block 220. Because this is the first play of the intermediate game and the limit is equal to three, the method continues to block 220.

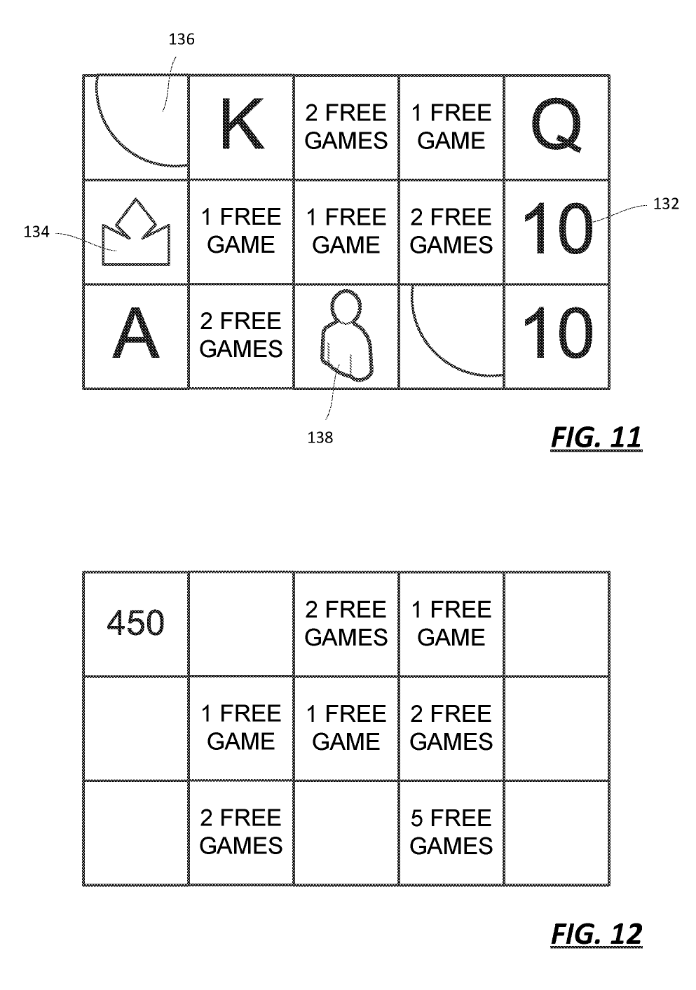

At block 220, the controller 108 determines if the player has used the game input(s) 110, for example, to cause the game symbol positions to be spun (or re-spun) as part of the intermediate event. When the controller 108 determines that the player has used the game input(s) 110, the controller 108 may display an image, such as illustrated in FIG. 10, where an animation of a spinning reel is provided for each of the game symbol positions of the array 144 that were not held at block 214. According to this embodiment, each game position is treated separately from the other game symbol positions, or at least it appears to the player that each game symbol position is treated separately (as opposed to appearing to be part of a single spinning reel). After a time period has elapsed or when the player actuates a further control, for example, the controller 108 causes the display 104 to display a plurality of game symbols 132, 134, 136, 138 (block 222), such as is illustrated in FIG. 11. As illustrated in FIG. 11, there are card symbols 132, object symbols 134, and WILD symbols 138, which may appear “greyed out” (so as to indicate that they do not participate in the jackpot determination). In addition, there are a number of additional scatter symbols 136, which may appear brightly colored and active (so as to indicate that that they participate in the jackpot determination).

At block 224, the controller 108 determines if additional scatter symbols appear in a second plurality of game symbol positions other than the first plurality of game symbol positions during the one or more plays of the intermediate event. For example, in the embodiment illustrated in FIGS. 8 and 11, the array 144 included six scatter symbols 136 in a first plurality of game symbol positions in reels 2 to 4 in FIG. 8, and the array 144 includes eight scatter symbols 136 in a second plurality of game symbols positions in reels 1 to 4 in FIG. 11 (i.e., the six in reels 2 to 4 held from the play of the first game that triggered the event as illustrated in FIG. 8, and two new scatter symbols in reels 1 and 4 in the first play of the intermediate event as illustrated in FIG. 11). Because there are two additional scatter symbols in FIG. 11, the method continues to blocks 226, 228, 232 and, optionally, 230.

The controller 108 may randomly determine at block 226 a number of additional free plays of the second game for each of the one or more additional scatter symbols that appear. According to certain embodiments, the number of additional free plays determined at block 226 may have a lower limit that is greater than the lower limit for the number of free plays determined at block 212 (e.g., the number of plays determined at block 226 may be greater than or equal to two (2), instead of greater than or equal to one (1)). According to still other embodiments, the controller 108 may randomly determine a number of additional free plays of the second game to be assigned to the group of scatter symbols 136 that appear (which number then may be associated with each individual symbol 136, or may be distributed over the symbols 136 newly appearing by equally dividing the number of games among the newly appearing symbols 136, for example).

As a further alternative, the controller 108 may randomly determine a game element other than a free play for each of the one or more additional scatter symbols that appear. For example, the controller 108 may randomly determine to award a number of credits to the player instead of one or more additional free plays. As illustrated in FIG. 12, the controller 108 has determined to provide 5 additional free plays for the additional scatter symbol 136 that appeared in reel 4, and 450 credits for the additional scatter symbol that appeared in reel 1. The 450 credits would be added to a total to be provided to the player at the end of the intermediate event; for example.

The method 200 may then continue to block 228, where the controller 108 determines if scatter symbols 136 appear in all of the game symbol positions of the array 144 during this play of the one or more plays of the intermediate event. According to other embodiments, a number less than all of the game symbol positions may be used as the threshold for the determination at block 228. If the controller 108 determines that all of the game symbol positions have been filed in this or previous plays by scatter symbols, then the method 200 may continue to block 230, and the controller 108 may award a prize to the player and terminate the intermediate event. As illustrated; the method 200 may further continue to the second game illustrated in FIG. 5.

According to one embodiment, the prize awarded to the player at block 230 may be a progressive jackpot, although other jackpots may be awarded instead.

On the other hand, if the controller 108 determines that scatter symbols 136 do not appear in all of the game symbol positions of the array 144, then the method continues to block 232, wherein the additional scatter symbols are held (like the scatter symbols from the first game as in FIG. 8), the limit is reset to 3, and the method returns to block 218. Moreover, because at least one additional game symbol appeared in this first play of the intermediate event; the limit has not been decreased and is still non-zero (i.e., it remains at 3). Consequently, the method will continue through block 218 and to blocks 220.

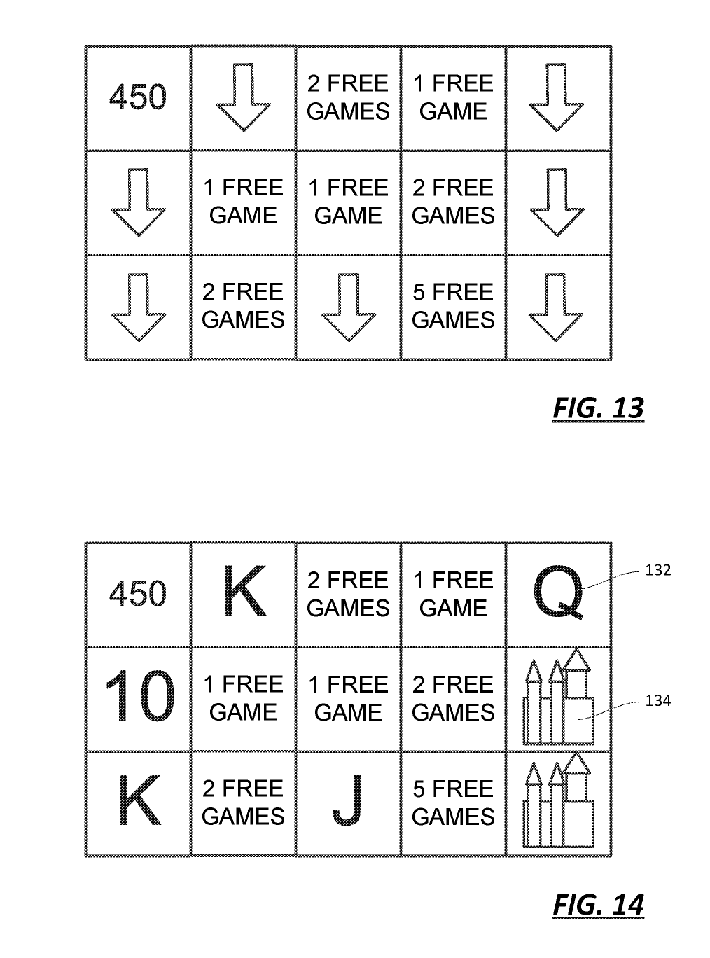

As illustrated in FIG. 13, on this second play of the intermediate event, the scatter symbols 136 (as represented by text announcements of the game elements—free plays or other—awarded for those scatter symbols) are held while animations of spinning “reels” are displayed in the remaining unoccupied game symbol positions. After a time period has elapsed or when the player actuates a further control, for example, the controller 108 causes the display 104 to display a plurality of game symbols (block 222), such as is illustrated in FIG. 14. As illustrated in FIG. 14, there are card symbols 132 and object symbols 134 in the game symbol positions previously unoccupied by scatter symbols, and thus re-spun, although the symbols 132, 134 may appear “greyed out” (so as to indicate that they do not participate in the jackpot determination). There are no additional scatter symbols 136.

As such, the controller 108 determines that one or more additional scatter symbols do not appear in the second plurality of game symbol positions at block 224. As mentioned above, according to certain embodiments, the controller 108 may be configured to terminate the intermediate event and continue to the second game at this point. That is, the controller 108 may terminate the event in the first instance, or play, that one or more additional scatter symbols 136 do not appear in the second plurality of game symbol positions.

According to the illustrated embodiment, play of the intermediate event does not terminate after the first play in which one or more additional symbols 136 do not appear. Instead, it takes more than one instance or play, as mentioned above. Therefore, the controller 108 at block 234 decrements the limit, initialized to three (3), by one for each play of the intermediate event that does not result in one or more additional scatter symbols 136 being displayed. The method 200 then returns to block 218, where the controller 108 determines if the limit is now equal to zero. Because the limit has only been decreased by one, the limit is now two (2), and the method proceeds again to block 220 and so on.

Over time, the limit will continue to be decreased for each play in which one or more additional scatter symbols 136 are not displayed or if additional scatter symbols are displayed, additional game events are determined for these additional scatter symbols displayed, the scatter symbols are held, and the limit is reset.

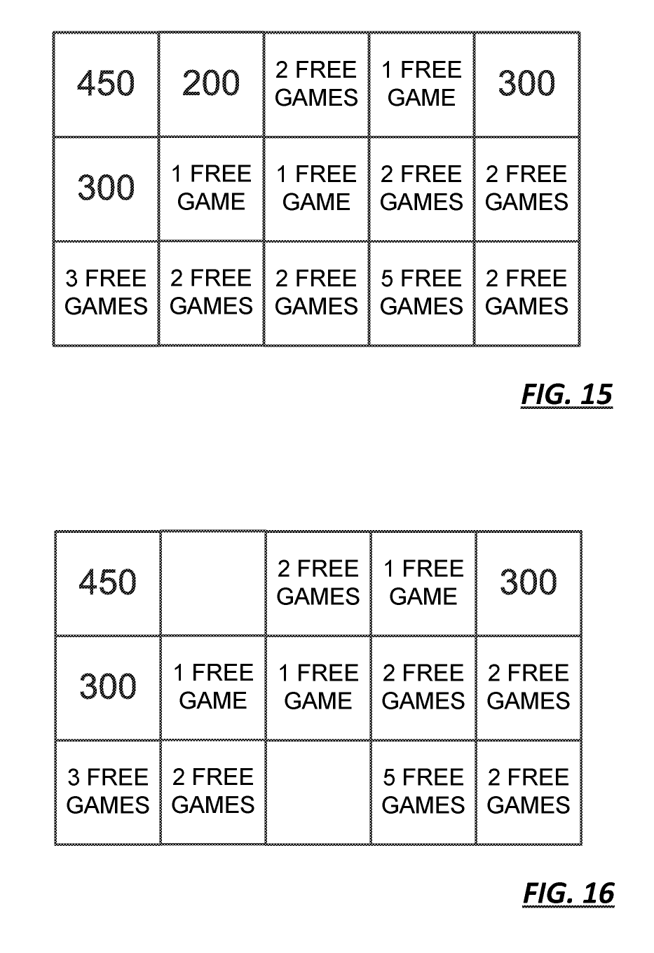

If the controller 108 determines at block 228 that all of the game symbol positions are occupied by a scatter symbol 136 (whether because of held scatter symbols or newly displayed scatter symbols 136), then the controller 108 awards a prize, for example a jackpot (such as a progressive jackpot), at block 230 and continues to the second game. FIG. 15 illustrates one example of the array 144 wherein all of the game symbol positions have been occupied by scatter symbols. According to such an example, the controller 108 would award the following for the array 144 as illustrated in FIG. 15: the jackpot prize (because all of the game symbol positions have been occupied by scatter symbols 136), an additional 1350 credits (the sum of the credit awards of 200, 300, 300, 450), and 23 free plays of the second game (the sum of the free play awards). According to other embodiments, the controller 108 may award only the jackpot prize and free plays, and not any other game elements (e.g., additional credits).

If the controller 108 does not determine at block 228 that all of the game symbol positions are occupied, but instead determines at block 218 that the limit has been reached (e.g., the limit is equal to zero (0) according to the illustrated embodiment), then the controller may still award the player the game elements determined for each of the scatter symbols that were displayed. FIG. 16 illustrates an exemplary array 144 for an intermediate event where not all of the game symbol positions are occupied by scatter symbols 136. According to such an example, the controller 108 would award the player 1050 credits (the sum of the credit awards of 300, 300, 450) and 21 free plays of the second game (the sum of the free play awards). The method 200 would then proceed to the second game illustrated in FIG. 5.

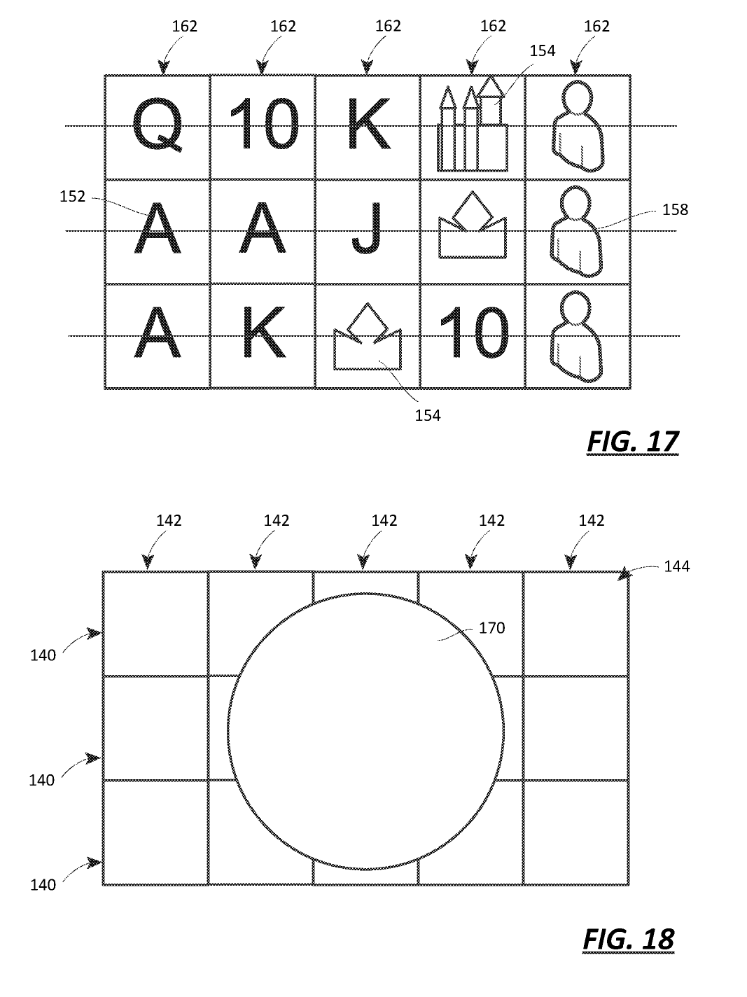

The second game may include one or more configurations of game symbols in an array of game symbol positions, one or more of the configurations of game symbols being associated with a game outcome, the game outcome being associated with a prize payable to a player. As such, the second game may be similar to the first game in appearance and operation. See FIG. 17. According to other embodiments, the second game may be considerably different from the first game (i.e., in the form of keno or bingo, for example).

When the method 200 continues to the second game, the controller 108 initially changes the game at block 236. According to some embodiments, the change from the first game to the second game may include the use of free plays awarded for the scatter symbols 136 instead of value wagers. Otherwise, the second game itself, as mentioned above, may be similar in appearance and operation. Alternatively, change from the first game to the second game may involve changing the game displayed and the rules by which the game is played (e.g. changing from a slots-type game to a keno game), also in keeping with the remarks above.

According to the illustrated embodiment, the second game is similar to the first game, but play occurs because of (and according to the number of) free plays awarded for the scatter symbols 136 previously. Thus, the method 200 may initially determine if there are additional free plays to be used at block 238 (i.e., if the number of free plays does not equal zero (0)). If there are additional free plays to be used at block 238, the method 200 may proceed to block 240, where it is determined where the controller 108 determines if the player has used the game input(s) 110, for example, to start the second game.

When the controller 108 determines that the player has used the game input(s) 110 to start the second game, the controller 108 may display an image, similar to FIG. 7, wherein an animation of a spinning reel is provided for each of the columns (block 242). According to other embodiments, the controller may display an image where an animation of a spinning reel is provided for each of the game symbol positions of the array. The animation may be of a downwardly pointing arrow and/or a blurred image of the game symbols as if they were in movement in a downward direction in the column (or game symbol position). After a time period has elapsed or when the player actuates a further control, for example, the controller 108 causes the display 104 to display a plurality of game symbols 152, 154, 158 (block 244), such as is illustrated in FIG. 17.

The game symbols 152, 154, 158 displayed in the second game may be visually and operationally similar to the game symbols 142, 144, 148 displayed in the first game. For example, the game symbols 152, 154 may represent card ranks (or ordinal values) and objects, respectively, similar to game symbols 142, 144. Further, game symbols 158 may be WILD symbols, which may be used in place of the game symbols 152, 154 when determining if a winning combination of game symbols is present, similar to game symbols 148. In addition, the game symbols 152, 154, 158 of the second game may be defined by the same theme, such as a princess or goddess theme, as the first game: the object game symbols 154 may include crowns and castles, for example, and the WILD symbols 158 may include a figure that is intended to represent the princess or goddess.

Even with such similarities, there may also be differences between the first and second games. For example, the array 144 of the first game and the array 164 of the second game may each be arranged in a plurality of columns, or reels, 142, 162. In addition, each reel 142, 162 may have a reel strip associated with the reel 142, 162, which reel strip controls the frequency and order of appearance of the symbols 152, 154, 158 for each of the reels 142, 162. According to certain embodiments, at least one of the reel strips associated with the plurality of reels 142 of the first game may be different from a corresponding reel strip associated with the plurality of reels 162 of the second game. For example, the number of WILD symbols 158 appearing on the reel strips for the reels 162 of the second game may be larger than the number of WILD symbols 148 appearing on the same reel strips for the reels 142.

Other differences may also exist. For example, according to certain embodiments, the trigger event of the first game is not present in the second game. Consequently, there are no scatter symbols displayed during the second game (i.e., there are no scatter symbols on the reel strips associated with the reels 162). Further, symbols may be held during one or more plays of the second game. For example, as illustrated in FIG. 17, the game symbols positions of the fifth, or rightmost, column 162 may be entirely occupied by WILD symbols 158, which WILD symbols 158 are displayed for all plays of the second game.

After displaying the symbols 152, 154, 158 at block 244, the method 200 continues to block 246, where the controller 108 determines if any winning combinations of game symbols have been displayed and the associated award. If one or more winning combinations have been displayed, the player's award balance for the second game is increased by that amount. According to the illustrated embodiment, because the fifth reel 162 is occupied by WILD symbols 158 for each play of the second game, the machine 100 (controller 108) would not award for 4 of a kind along a payline, but only for 2, 3 or 5 of a kind on a payline. After making the determination at block 246, the method 200 continues to block 248 where the controller 108 decreases the number of free plays of the second game by one. The method 200 then returns to block 238, and repeats blocks 240 to 248 until the number of free plays equals zero (0). At that point, the method 200 continues to block 250, where the controller 108 awards the cumulative total of the awards from the second game to the player's account and returns to block 204 (FIG. 4).

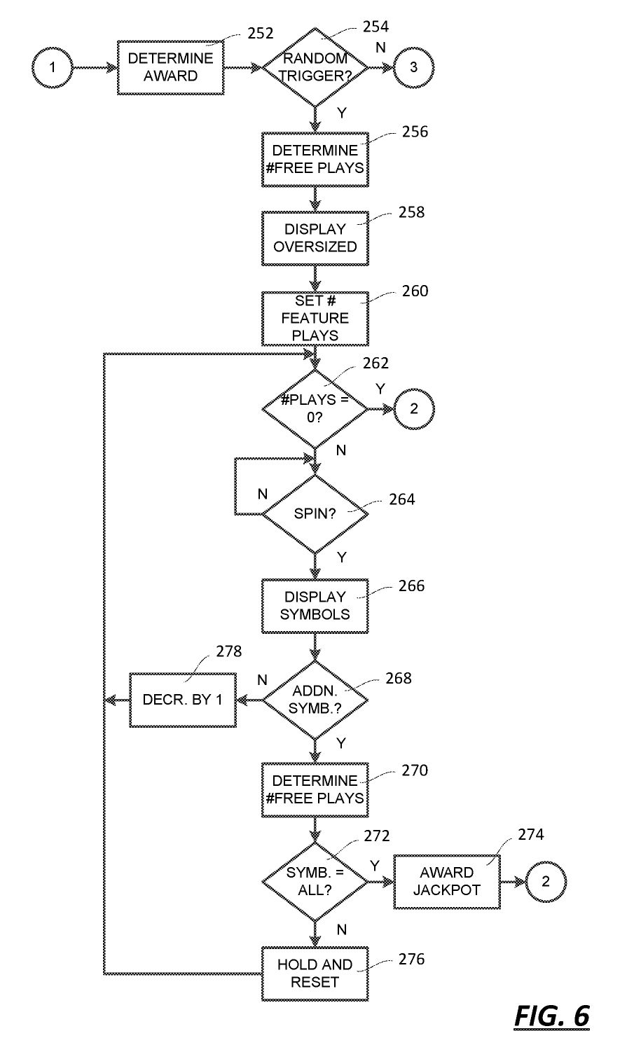

According to certain embodiments, including the illustrated embodiment, if the trigger event has not occurred (as determined at block 210, FIG. 4), the controller 108 may be configured to randomly determine if the second game is to be played at block 254 after determining any award for winning combinations displayed in the first game at block 252. See FIG. 6. If the controller 108 does not randomly determine that the second game will be played at block 254, the method 200 may return to block 204 in FIG. 4. If the controller does determine that the second game will be played, the method 200 may continue to block 256.

At block 256, the controller 108 determines a number of free plays for the second game associated with the random triggering of the second game. According to certain embodiments, the controller 108 may be configured to randomly determine the number of free plays during the second game. Alternatively, the controller 108 may be configured to determine a number of free games to be played during the second game according to a number of scatter symbols displayed during the first game.

According to some embodiments, the method may proceed from block 256 to the second game. According to the illustrated embodiments, the method 200 instead continues to a variation on the intermediate event described in regard to FIG. 4 and illustrated in FIGS. 8-16. That is, the randomly triggered intermediate event also involves a combination of held game symbols and re-spun game symbol positions, the result of which may be an award of a jackpot. The specifics of the randomly-triggered intermediate event differ from that of the earlier-described intermediate event.

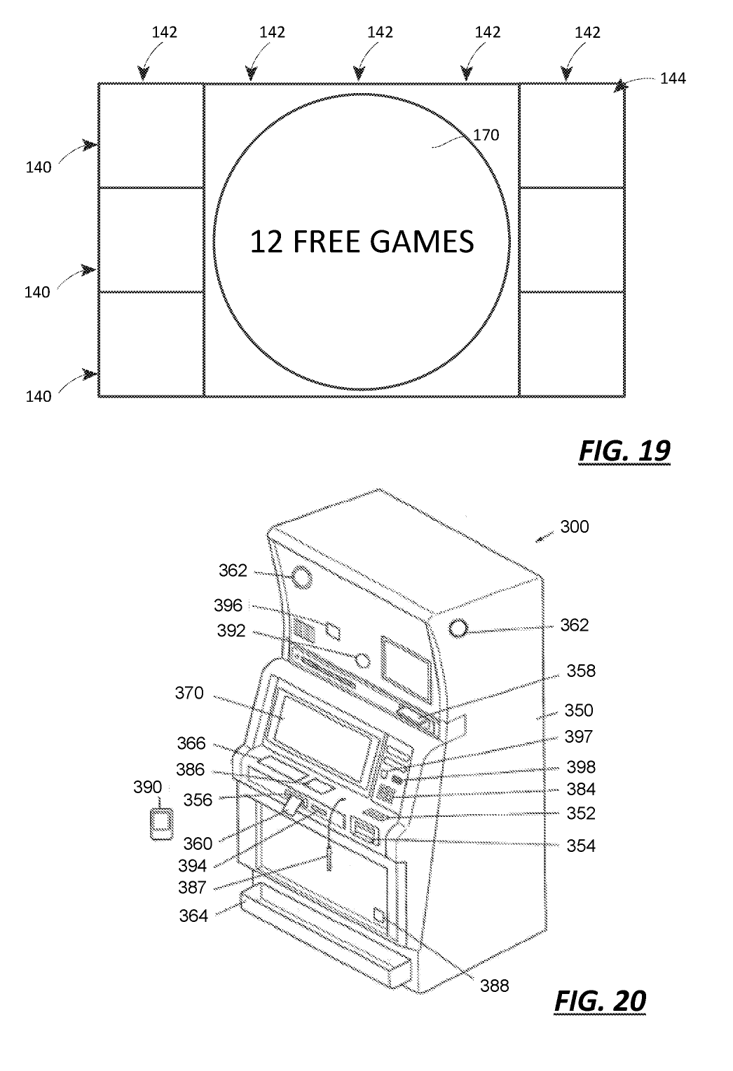

As illustrated in FIG. 6, the method 200 continues from block 256 to block 258, where the controller 108 controls the display 104 to display an oversized game symbol 170 that overlaps a first plurality of game symbol positions during one or more plays of the intermediate event. The oversized game symbol 170 overlaps with the game symbol positions in the second, third, and fourth (i.e., the middle three) columns of the array 144. This oversized game symbol 170 is then held for all of the plays of the randomly triggered intermediate event. The number of free plays awarded to the player for the random triggering of the intermediate event may be displayed with the oversized game symbol 170 (e.g., by overwriting text on the game symbol 170). See FIG. 19.

The method 200 would then proceed similar to the scatter symbol-triggered intermediate event discussed above. That is, the method 200 would proceed to block 260, where the controller 108 sets a limit on the number of plays of the intermediate event. Block 260 may be omitted for those embodiments where the randomly-triggered intermediate event only has a single play. Further, while some embodiments may set a fixed or static limit on the number of plays (similar to the limit used in FIG. 5), the illustrated embodiment uses a dynamic limit that is initialized, for example, to 3 (similar to the limit used in FIG. 4).

Thus, at block 262, the controller 108 determines if the limit has been reached (i.e., if the number of free plays equals zero (0)). If the number of free plays is equal to zero (0), then the method 200 passes to the second game, illustrated in FIG. 5. If the number of free plays is not equal to zero (0), then the method 200 continues to block 264, where the controller 108 determines if the input 110 has been used to initiate the spin (or re-spin). If it has, then the method continues to block 266, where the controller 108 causes the game symbol positions not occupied by the oversized symbol 170 (or other scatter symbols 142 as may be displayed during the intermediate event) to first display a spinning reel or game symbol position animation and then to display a game symbol. As illustrated in FIG. 19, the controller would cause this to occur with respect to the first and fifth columns 142 that are not wholly or partially occupied by the oversized symbol 170.

At block 268, the controller 108 determines whether one or more additional scatter symbols 146 are displayed in a second plurality of game symbol positions (i.e., the first and fifth columns). If the controller 108 determines that one or more additional scatter symbols 146 have been displayed, then the method 200 continues to block 270, where the controller 108 determines (e.g., randomly) a number of additional free plays of the second game for each of the one or more additional scatter symbols that appear. Moreover, the controller 108 may be configured to determine if scatter symbols 146 appear in all of the game symbol positions of the array 144 during the one or more plays of the intermediate event at block 272, and to award a prize at block 274 if the scatter symbols 146 appear in all of the game symbol positions, to terminate the randomly-triggered intermediate event and continue to the second game. If less than all of the game symbols positions of the array 144 are occupied by scatter symbols 146 but at least one additional scatter symbol 146 has been displayed during the play, the controller 108 holds the oversized symbol 170 and the one or more additional scatter symbols 146 and resets the limit to 3 at block 276, and returns to block 262.

On the other hand, if one or more additional scatter symbols 146 do not appear in the second plurality of game symbol positions, the controller 108 may be configured to terminate the intermediate event (and continue to the second game). According to the illustrated embodiment, the controller 108 does not terminate the intermediate event after one play, but instead decreases the limit by one at block 278 for each play where no additional scatter symbols 146 are displayed until the limit is equal to zero (0). As mentioned above, the limit is initialized to three, meaning that the randomly-triggered intermediate event does not terminate until three plays have occurred where no additional scatter symbols 146 have been displayed. According to other embodiments, the limit may be initialized to a number larger than three, or the limit may be initialized to one or two. Further, a static limit may be substituted for the dynamic limit used in the illustrated embodiment.

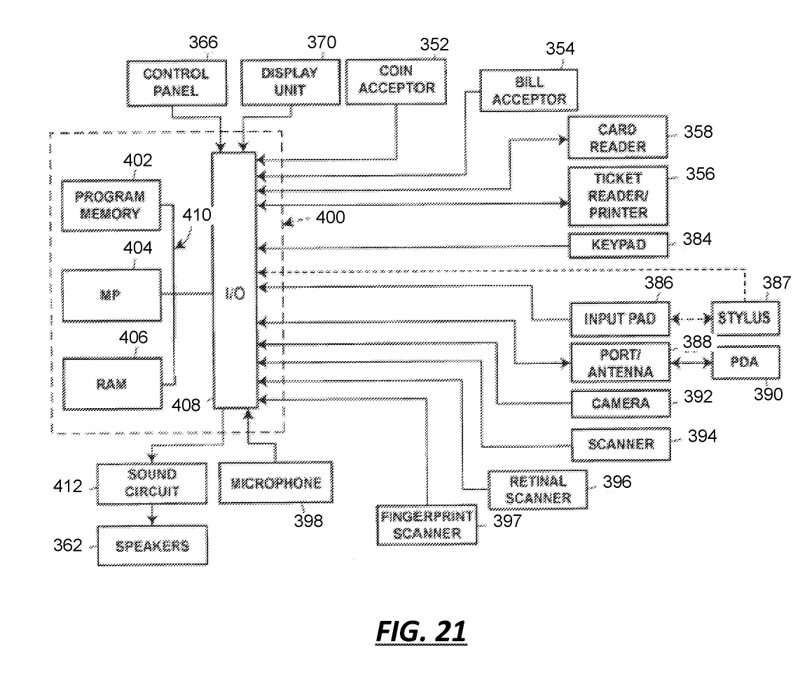

Having thus discussed methods of operation of a gaming device, other embodiments of a gaming device that may operate according to such methods are now discussed with reference to FIGS. 20 and 21.

Referring to FIG. 20, another embodiment is shown in the form of an electronic gaming machine 300. The electronic gaming machine 300 may include a housing or cabinet 350 and one or more value transfer mechanisms or devices, which may include a coin slot or acceptor 352, a paper currency or bill acceptor 354, a ticket reader/printer 356 and a card reader 358 as illustrated, which may be used to input value to the electronic gaming machine 300. In general terms, a value transfer device may include any device that can accept value from a player, wherein term “value” means credits, gaming tokens, coins, paper, currency, tickets, vouchers, credit cards, debit cards, smart cards, memory devices capable of storing value (e.g., a memory card, smart card, a radio frequency identification (RFID) device, USB key, magnetic card or other electronic storage device) and any other object representative of value, and a value transfer device may include an electronic funds transfer device.

If provided on the electronic gaming machine 300, the ticket reader/printer 356 may be used to read and/or print or otherwise encode ticket vouchers 360. The ticket vouchers 360 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 360 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 360 could be printed with an optically readable material such as ink, or data on the ticket vouchers 360 could be magnetically encoded. The ticket reader/printer 356 may be provided with the ability to both read and print ticket vouchers 360, or it may be provided with the ability to only read or only print or encode ticket vouchers 360. In the latter case, for example, some of the electronic gaming machines 300 may have ticket printers 356 that may be used to print ticket vouchers 360, which could then be used by a player in other electronic gaming machines 300 that have ticket readers 356.

If provided, the card reader 358 may include any type of card reading device, such as a magnetic card reader or an optical card reader, and may be used to read data from a card offered by a player, such as a credit card or a player-tracking card. If provided for player tracking purposes, the card reader 358 may be used to read data from, and/or write data to, player tracking cards that are capable of storing data representing the identity of a player, the identity of a casino, the player's gaming habits, etc.

The electronic gaming machine 300 may include one or more audio speakers 362, a coin payout tray 364, an input control panel 366, and a color video display unit 370 for displaying images relating to the game or games provided by the electronic gaming machine 300. The audio speakers 362 may generate audio representing sounds such as the noise of spinning reels, a dealer's voice, music, announcements or any other audio related to a game. The input control panel 366 may be provided with a plurality of pushbuttons or touch-sensitive areas that may be pressed by a player to select games, make wagers, make gaming decisions, etc. The buttons used may depend on the game or games that could be played on the electronic gaming machine 300. As used herein, the term “button” is intended to encompass any device that allows a player to make an input, such as an input device that must be depressed to make an input selection or a display area that a player may simply touch. For example, the control panel 366 could be generated by the display unit 370. In that case, each of the buttons of the control panel 366 could be a colored area generated by the display unit 370, and some type of mechanism may be associated with the display unit 370 to detect when each of the buttons was touched, such as a touch-sensitive screen.

The electronic gaming machine 300 also may include a mechanism by which the electronic gaming machine 300 may determine the identity of the player. In particular, the card reader 358 may be used to read a card that carries an identification code that may be uniquely associated with the player so that the gaming unit can differentiate that player from all other players, or so that the gaming unit can differentiate that player as a member of a group of players from all player not a member of the group of players. The electronic gaming machine 300 may also include equipment, such as a keypad 384, an input pad 386 (with optional stylus 387), a port (or antenna) 388 adapted to communicate via a wired or wireless link (infrared or radio frequency link, for example) to a mobile electronic device 390 (such as a personal digital assistant, smart phone or tablet), a camera 392, a scanner 394, a retinal (or iris) scanner 396, fingerprint scanner 397, and/or a microphone 398. The electronic gaming machine 300 may include any one of the devices 358, 384, 386, 388, 390, 392, 394, 396, 397, 398, or the electronic gaming machine 300 may include a combination of some or all of the devices 358, 384, 386, 387, 388, 390, 392, 394, 396, 397, 398.

In operation, a player may identify him or herself to the electronic gaming machine 300 by entering a unique numeric or alphanumeric code using the key pad 384, for example. Alternatively, the player may use his or her finger or the stylus 387 to sign his or her signature on the input pad 386. As a further alternative, the player may sign his or her signature on the mobile electronic device 390, which signature is then converted to electronic data, and the data is then transferred via the port/antenna 388 to the electronic gaming machine 300. As yet another alternative, the player may sign his or her signature on a piece of paper that is then photographed using the camera 392 or scanned using the scanner 394 (or the bill acceptor 354) to convert the signature into electronic data. As an additional alternative, the player may place one of his or her fingers or his or her hand on the scanner 397, and the scanner 397 may generate an electronic data representation of the fingerprint on one or more of the player's fingers or an electronic data representation of the pattern of the entire hand. Alternatively, the camera 392 may be used to take a picture (live or still) of the player, the picture then being converted into electronic data. As a still further alternative, the player may place his or her eye up to the retinal (or iris) scanner 396, and the retinal (or iris) scanner 396 may generate an electronic data representation corresponding to the pattern of the retina (or iris) of the player. As yet another alternative, the player may speak into the microphone 398, and characteristics of the spoken words (or voiceprint) may be converted into an electronic data representation.

FIG. 21 is a block diagram of a number of components that may be incorporated in the electronic gaming machine 300. Referring to FIG. 21, the electronic gaming machine 300 may include a controller 400 that may comprise a program memory 402, a microcontroller or microprocessor (MP) 404, a random-access memory (RAM) 406 and an input/output (I/O) circuit 408, all of which may be interconnected via an address/data bus 410. It should be appreciated that although only one microprocessor 404 is shown, the controller 400 may include multiple microprocessors 404. Similarly, the memory of the controller 400 may include multiple RAMs 406 and multiple program memories 402. Although the I/O circuit 408 is shown as a single block, it should be appreciated that the I/O circuit 408 may include a number of different types of I/O circuits. The RAM(s) 404 and program memories 402 may be implemented as semiconductor memories, magnetically readable memories, and/or optically readable memories, for example.

FIG. 21 illustrates that the coin acceptor 352, the bill acceptor 354, the ticket reader/printer 356, the card reader 358, the control panel 366, the display unit 370, the keypad 384, the input pad 386 (and optionally the stylus 387), the port/antenna 388, the digital camera 392, the scanner 394, the retinal scanner 396, the fingerprint scanner 397 and the microphone 398 may be operatively coupled to the I/O circuit 408, each of those components being so coupled by either a unidirectional or bidirectional, single-line or multiple-line data link, which may depend on the design of the component that is used. The speaker(s) 362 may be operatively coupled to a sound circuit 412, that may comprise a voice- and sound-synthesis circuit or that may comprise a driver circuit. The sound-generating circuit 412 may be coupled to the I/O circuit 408.

As shown in FIG. 21, the components 352, 354, 356, 358, 366, 370, 384, 386, 387, 388, 392, 394, 396, 397, 398, 412 may be connected to the I/O circuit 408 via a respective direct line or conductor. Different connection schemes could be used. For example, one or more of the components shown in FIG. 21 may be connected to the I/O circuit 408 via a common bus or other data link that is shared by a number of components. Furthermore, some of the components may be directly connected to the microprocessor 404 without passing through the I/O circuit 408.

It will be recognized that other embodiments of the electronic gaming device may include fewer than all of the components illustrated in FIGS. 20 and 21, but greater than the components illustrated in FIGS. 1 and 2. Further, it is possible for embodiments of the electronic gaming device to include components in addition to those illustrated either the embodiment of FIGS. 1 and 2 or the embodiment of FIGS. 20 and 21. These embodiments are provided for exemplary purposes only.

In addition to the awards mentioned above (progressive jackpots, multipliers), the awards that are displayed in the queue may also include elements that provide different types of effects or modifications of the game play determination. In one embodiment, the awards are a predetermined number of free games. In some embodiments, the awards are at least one or more a win multiplier, wild multipliers, bonus wilds, symbols that cause the award of additional free games, trigger symbols to retrigger the at least two second arrays, held columns, random wild symbols, stacked symbols, bonus symbols, new game symbols, reveal symbols, progressives, bonus credits, jackpot symbols, and one or more symbol replacements. A variety of awards can be provided, including:
a predetermined number of free plays of the game;
multipliers that multiply the amount of any win from one of the predetermined winning combinations;
“wild” symbols that cause the display of substitute symbols in randomly selected symbol positions;
bonus symbols that awards a bonus prize, either as a monetary amount or as a bonus credit;
wild multiplier symbols that cause the display of substitute symbols on the array 144 and multiplies the amount of any win from one of the predetermined winning combinations;
bonus wild symbols that cause the display of substitute symbols on the array 144 and awards a bonus prize;
symbols that cause the award of additional free plays of the game;
symbols that cause one or more of the symbol positions to be held static (typically one or more reels 142) and display substitute symbols on the array 144;
symbols that cause the same game symbol to be stacked in a group of symbol positions, typically the group being one or more reels 142;
symbols that cause the display of new game symbols on the array 144;
“reveal” symbols that cause a game symbol to reveal another game symbol; and
“replacement” symbols that cause one or more game symbols to be replaced by other game symbols in the array 144.

So, in some embodiments, the at least one electronic controller is configured to determine if the trigger event has occurred by determining if a threshold number of scatter symbols have appeared during a play of the first game.

In some embodiments, the scatter symbols appear in a first plurality of game positions during play of the first game, and the at least one electronic controller is configured to hold the scatter symbols in the first plurality of game symbol positions during one or more plays of an intermediate event, and to determine if additional scatter symbols appear in a second plurality of game symbol positions other than the first plurality of game symbol positions during the one or more plays of the intermediate event.

In some embodiments, the electronic controller is configured to determine if one or more additional scatter symbols appear in the second plurality of game symbol positions, and to randomly determine a number of additional free plays of the second game for each of the one or more additional scatter symbols that appear.

In some embodiments, the electronic controller is configured to determine if one or more additional scatter symbols appears in the second plurality of game symbol positions, and to terminate the intermediate event if one or more additional scatter symbols do not appear in the second plurality of game symbol positions.

In some embodiments, the electronic controller is configured to determine if scatter symbols appear in all of the game symbol positions of the array during the one or more plays of the intermediate event, to award a prize if the scatter symbols appear in all of the game symbol positions, and to terminate the intermediate event and continue to the second game.

In some embodiments, if the trigger event has not occurred, to randomly determine if the second game is to be played, and if the second game is randomly determined to be played, determine a number of free plays for the second game.

In some embodiments, the second game is randomly determined to be played and the at least one electronic controller is configured to display an oversized game symbol that overlaps a first plurality of game symbol positions during one or more plays of an intermediate event; and to determine if additional scatter symbols appear in a second plurality of game symbol positions other than the first plurality of game symbol positions during the one or more plays of the intermediate event.

In some embodiments, the electronic controller is configured to determine if one or more additional scatter symbols appear in the second plurality of game symbol positions, and to randomly determine a number of additional free plays of the second game for each of the one or more additional scatter symbols that appear.

In some embodiments, wherein the electronic controller is configured to determine if one or more additional scatter symbols appears in the second plurality of game symbol positions, and to terminate the intermediate event if one or more additional scatter symbols do not appear in the second plurality of game symbol positions.

In some embodiments, the electronic controller is configured to determine if scatter symbols appear in all of the game symbol positions of the array during the one or more plays of the intermediate event, to award a prize if the scatter symbols appear in all of the game symbol positions, and to terminate the intermediate event and continue to the second game.

In some embodiments, the electronic controller is configured, if the second game is randomly determined to be played, to randomly determine the number of free plays during the second game.

In some embodiments, the electronic controller is configured, if the second game is randomly determined to be played, to determine a number of free games to be played during the second game according to a number of scatter symbols displayed during the first game.

In some embodiments, the second game includes one or more configurations of game symbols in an array of game symbol positions, one or more of the configurations of game symbols being associated with a game outcome, the game outcome being associated with an prize payable to a player.

In some embodiments, the trigger event of the first game is not present in the second game.

In some embodiments, the array of the first game and the array of the second game are each arranged in a plurality of reels, each reel having a reel strip associated with the reel, at least one of the reel strips associated with the plurality of reels of the first game being different than a corresponding reel strip associated with the plurality of reels of the second game.

In conclusion, although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed is:

1. A gaming machine comprising:
at least one display;
a value input comprising at least one of a coin acceptor, a bill acceptor and a ticket reader; and
at least one electronic controller coupled to the at least one display and the value input, the at least one controller configured:
to determine if a wager has been received via the value input;
to display a first game on the at least one display including one or more configurations of game symbols in an array of game symbol positions if a wager has been received, one or more of the configurations of game symbols being associated with a game outcome, the game outcome being associated with an prize payable to a player;
to determine if a trigger event has occurred during a play of the first game, and if the trigger event has occurred, to randomly determine a number of free plays for a second game.

2. The gaming machine according to claim 1, wherein the at least one electronic controller is configured to determine if the trigger event has occurred by determining if a threshold number of scatter symbols have appeared during a play of the first game.

3. The gaming machine according to claim 2, wherein the scatter symbols appear in a first plurality of game positions during play of the first game, and the at least one electronic controller is configured:
to hold the scatter symbols in the first plurality of game symbol positions during one or more plays of an intermediate event, and
to determine if additional scatter symbols appear in a second plurality of game symbol positions other than the first plurality of game symbol positions during the one or more plays of the intermediate event.

4. The gaming machine according to claim 3, wherein the electronic controller is configured to determine if one or more additional scatter symbols appear in the second plurality of game symbol positions, and to randomly determine a number of additional free plays of the second game for each of the one or more additional scatter symbols that appear.

5. The gaming machine according to claim 3, wherein the electronic controller is configured to determine if one or more additional scatter symbols appears in the second plurality of game symbol positions, and to terminate the intermediate event if one or more additional scatter symbols do not appear in the second plurality of game symbol positions.

6. The gaming machine according to claim 3, wherein the electronic controller is configured to determine if scatter symbols appear in all of the game symbol positions of the array during the one or more plays of the intermediate event, to award a prize if the scatter symbols appear in all of the game symbol positions, and to terminate the intermediate event and continue to the second game.

7. The gaming machine according to claim 1, wherein, if the trigger event has not occurred, to randomly determine if the second game is to be played, and if the second game is randomly determined to be played, determine a number of free plays for the second game.

8. The gaming machine according to claim 7, wherein the second game is randomly determined to be played and the at least one electronic controller is configured:
to display an oversized game symbol that overlaps a first plurality of game symbol positions during one or more plays of an intermediate event; and
to determine if additional scatter symbols appear in a second plurality of game symbol positions other than the first plurality of game symbol positions during the one or more plays of the intermediate event.

9. The gaming machine according to claim 8, wherein the electronic controller is configured to determine if one or more additional scatter symbols appear in the second plurality of game symbol positions, and to randomly determine a number of additional free plays of the second game for each of the one or more additional scatter symbols that appear.

10. The gaming machine according to claim 8, wherein the electronic controller is configured to determine if one or more additional scatter symbols appears in the second plurality of game symbol positions, and to terminate the intermediate event if one or more additional scatter symbols do not appear in the second plurality of game symbol positions.

11. The gaming machine according to claim 8, wherein the electronic controller is configured to determine if scatter symbols appear in all of the game symbol positions of the array during the one or more plays of the intermediate event, to award a prize if the scatter symbols appear in all of the game symbol positions, and to terminate the intermediate event and continue to the second game.

12. The gaming machine according to claim 7, wherein the electronic controller is configured, if the second game is randomly determined to be played, to randomly determine the number of free plays during the second game.

13. The gaming machine according to claim 7, wherein the electronic controller is configured, if the second game is randomly determined to be played, to determine a number of free games to be played during the second game according to a number of scatter symbols displayed during the first game.

14. The gaming machine according to claim 1, wherein the second game includes one or more configurations of game symbols in an array of game symbol positions, one or more of the configurations of game symbols being associated with a game outcome, the game outcome being associated with an prize payable to a player.

15. The gaming machine according to claim 14, wherein the trigger event of the first game is not present in the second game.

16. The gaming machine according to claim 14, wherein:
the array of the first game and the array of the second game are each arranged in a plurality of reels, each reel having a reel strip associated with the reel,
at least one of the reel strips associated with the plurality of reels of the first game being different than a corresponding reel strip associated with the plurality of reels of the second game.
